(19) United States
(12) Patent Application Publication
(10) Pub. No.: US 2022/0064917 A1
(43) Pub. Date: Mar. 3, 2022

(54) Faucet Valve Assembly

(71) Applicant: Vann Stone Faison, Seattle, WA (US)

(72) Inventor: Vann Stone Faison, Seattle, WA (US)

(21) Appl. No.: 17/002,777

(22) Filed: Aug. 26, 2020

(51) Int. Cl. E03C 1/04; F16K 11/078; F16K 11/22; F16K 31/60; F16K 27/04

(52) U.S. Cl. CPC E03C 1/0412; F16K 11/0782; F16K 27/045; F16K 31/605; F16K 11/22

(57) ABSTRACT

The present application discloses faucet valve assembly mounted below the mounting surface. The basic structure may comprise a valve assembly secured on the bottom or back side of a mounting surface with a valve assembly control knob secured on the other side of the mounting surface. This would allow for the knob to control the faucet fluid temperature and pressure through the mounting surface.

### TECHNICAL FIELD

The present application relates to a faucet valve assembly. More specifically, the present application relates to a faucet valve assembly that mounts below or behind a mounting surface to control fluid pressure, temperature and mixing.

### BACKGROUND

The intended purpose of this section is to provide context to the invention that is stated in the claims. The description herein may include concepts that have the ability to be performed, but have not necessarily been previously performed or conceptualized.

In an example, when a user interacts with a faucet valve assembly, it is an assembly that is located above the mounting surface. This faucet valve assembly is limited in that it takes up counter space.

In another example, a user may interact with a faucet valve assembly that has two valves. These valves may control hot and cold water independently from a fluid source. This may require two independent control knobs for the faucet valve assembly. This faucet valve assembly is limited in that a single control knob does not control multiple temperatures and pressures.

In another example, a faucet valve assembly may require one or more of the faucet mounting holes to have faucet components blocking the mounting hole or occupying the mounting hole. This prevents the ability for the mounting hole to contain a faucet hose or body as well as the fluid control for the faucet.

In all examples, although the faucet valve assemblies allow for control of the fluid source, and although there may be a knob that controls the fluid, the valves may be located on the operable side of the mounting surface and may require that they be controlled independently. Additionally, one or more mounting holes may not be able to have a fluid control as well as a faucet hose or body pass through. This can create hindrances in the use of the sink due to the excessive operable side space required for the faucet valve assembly and the complexity of controlling the fluid sources independently.

There is a a need for a new technology that may fix the shortcomings mentioned above.

### SUMMARY OF THE INVENTION

The present application discloses faucet valve assembly that is mounted beneath or behind the mounting surface. The faucet valve assembly may control fluid with one control knob location and may maintain a void through the mounting hole and through the faucet valve assembly. The faucet valve assembly may be used for hydraulic or pneumatic purposes. The basic structure may comprise a control knob that is located on the operable side of the mounting surface. The operable side of the mounting surface referred to herein as the side of the mounting surface intended for typical user interaction. The control knob may extend through the mounting surface and to another part of the valve assembly where it controls valves of which adjust fluid characteristics. The faucet valve assembly may allow for fluid mixing, fluid temperature adjustment, fluid pressure adjustment etc. from input on the operable side of the mounting surface.

### BRIEF DESCRIPTION OF DRAWINGS

FIG. 1 is an unlabeled perspective view of the faucet valve assembly.

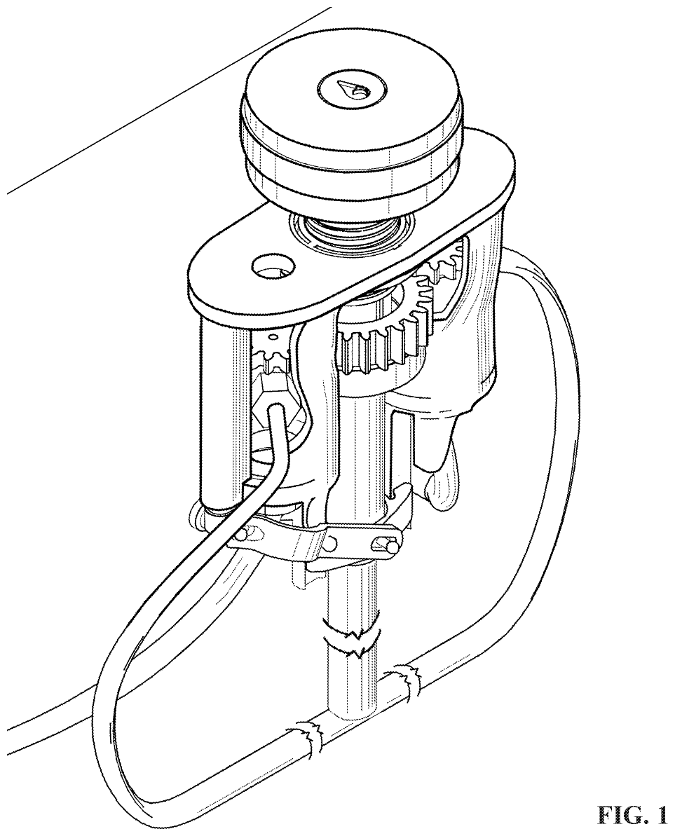

FIG. 2 is a labeled perspective view of the faucet valve assembly.

FIG. 3 is a labeled cross section of the faucet valve assembly.

FIG. 4 is a labeled cross section of the faucet valve assembly.

FIG. 5 is a labeled cross section of the faucet valve assembly.

FIG. 6 is a labeled cross section of the faucet valve assembly.

FIG. 7 is a labeled cross section of the faucet valve assembly.

### DETAILED DESCRIPTION

Prior to referencing the figures, it should be understood that all features related to particular embodiments, in the Summary, this Detailed Description, and the Claims, and in the Drawings can be used with other features to the extent possible. It should be understood that the current disclosure is not limited by the detail description or illustrations. Additionally, it should be understood that the terminology used is solely for the purpose of description and should not be inferred as limiting.

The present application discloses a faucet valve assembly that is positioned below a mounting surface. Certain tasks that a user may perform may require less obstructions on the operable side of the mounting surface while still maintaining fluid control. For example, a user cooking at home, may benefit from reduced obstructions over the sink area and adjacent to the sink faucet. A faucet valve assembly positioned below the counter may reduce the quantity of knobs and the size of the knob protruding around the sink area, and may provide more space through the mounting hole for a spay hose or faucet to dock. With the present invention, a user could change the pressure and temperature of the sink faucet from above the counter, while providing ample faucet mounting hole space for various faucet configurations.

Similarly, someone using a shower may find a faucet valve assembly positioned behind a mounting surface to be advantageous. Reduced knob and simplified mounting surface may provide an easier surrounding surface to clean.

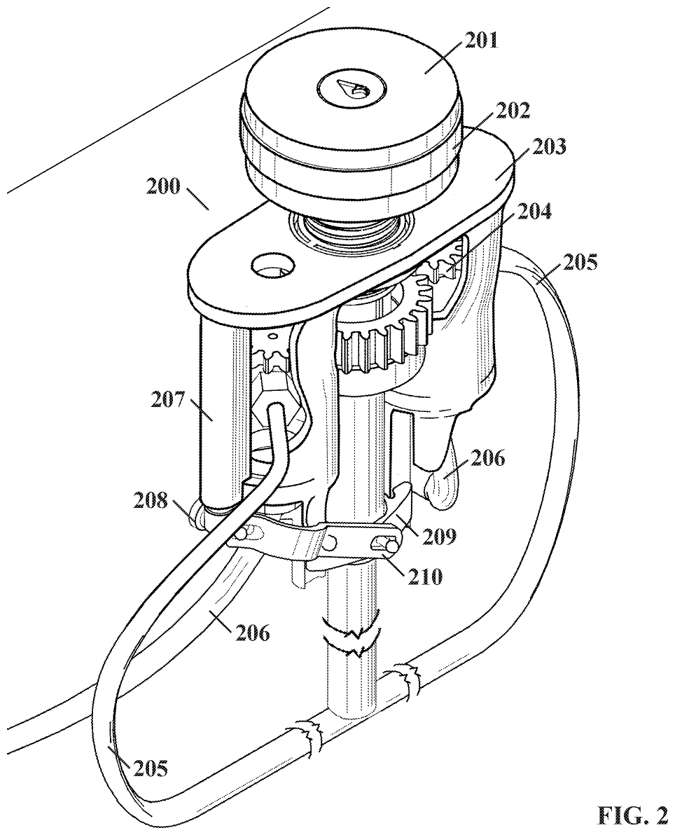

The present application discloses a faucet valve assembly mounted below the mounting surface shown in FIG. 2 as 200. The basic structure may comprise a control knob, shown in FIG. 2 as 201. The control knob may have grips, 202. Frame, 203, may contain various components in a position located below or behind the mounting surface. Frame 203 may position gears, pulleys, belts or wheels, 204, to transfer rotational movement from knob 201, above the mounting surface, to valve assembly components below the mounting surface. Faucet fluid source 206 may provide the fluid to the faucet valve assembly. Faucet fluid supply, 205 may supply the temperature and pressure adjusted fluid to the faucet. Spring loaded mechanism 207 may contain one or more spring loaded mechanism rotational joint 208, faucet head catch 209, and spring loaded mechanism leverage arm 210. These components may help to protrude a faucet head through the faucet valve assembly for the faucet user to be able to grab the faucet head to remove it from docking.

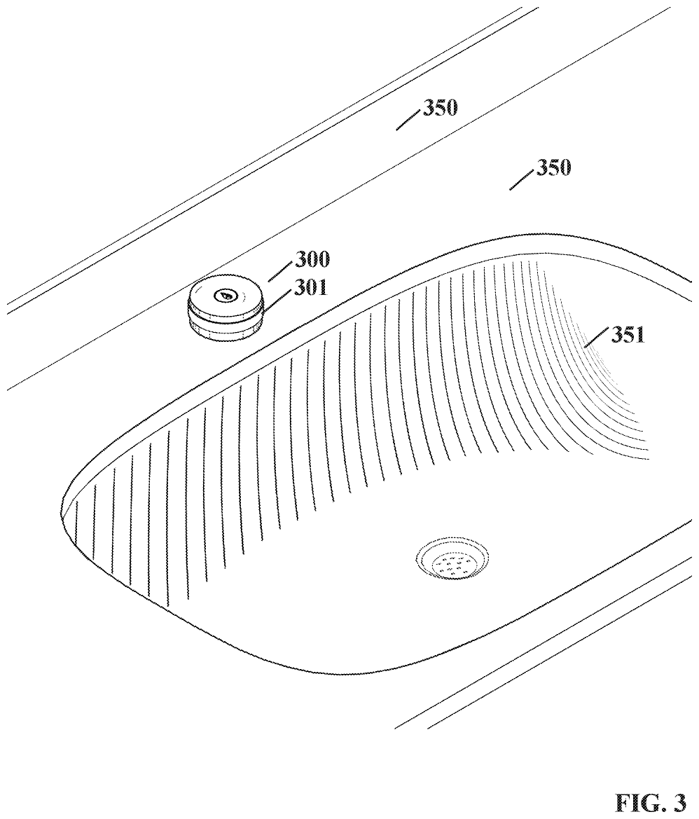

FIG. 3 is an illustrative embodiment of the operable side of a mounting surface. As shown in FIG. 3, components of the faucet valve assembly may be secured through the mounting surface, 350, so that they are not visible from the operable side of the mounting surface. Control knob 301 may be positioned so that it is visible and accessible to the user. Sink basin 351, is shown for reference and acts as the sink basin for which the faucet valve assembly may serve in one exemplary embodiment.

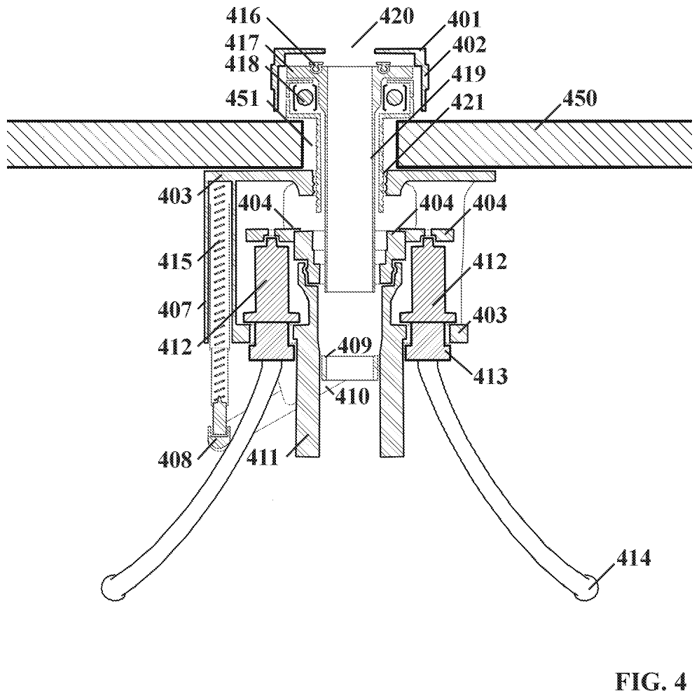

In some embodiments, The faucet valve assembly may be fixed through one central faucet mounting hole, 451. A cross-sectional view in FIG. 4 comprises a control knob, shown in FIG. 4 as 401. Control knob 401 may be pressure fit to the rest of the valve assembly for easy interchange. The control knob may have grips, 402. Frame, 403, may contain various components in a position located below the mounting surface. Frame 403 may position gears, pulleys, belts or wheels, 404, to transfer rotational movement from knob 401, from the operable side of the mounting surface, to at least one valve, 412. Stem 419 may transfer knob, 401, rotational movement to gears, pulleys, belts or wheels 404. Gears, pulleys, belts or wheels 404 may transfer rotational movement amongst at least two gears, pulleys, belts or wheels. The gears, pulleys, belts or wheels may be secured to valves 412. Valves 412, may control the faucet fluid source, 414, to result in the provided faucet fluid supply. The inlets and outlets for the faucet fluid source and supply may be at an adjacent, opposite or adjoining location. Valve 412 may reside within frame 403 or it may be part of frame 403. Faucet Frame 403 may contain one or more spring loaded mechanism 407 of which has one or more spring 415, one or more spring loaded mechanism rotational joint 408, one or more faucet head catch 409, one or more spring loaded mechanism leverage arm 410 and one or more spring loaded mechanism slide tracks 411. The spring loaded mechanism may catch a faucet head that is lowered through the central void 420, spring loaded mechanism slide tracks, 411, may keep the faucet head catch 409 aligned while the spring 415 is compressed due to the rotation of the spring loaded mechanism leverage arm 410. The spring loaded mechanism may lock in place when compressed. When released, the spring loaded mechanism 407 may slide the faucet head catch along the spring loaded mechanism slide tracks, 411. The result may be an extension of the faucet through knob 401 for the user to be able to grab and pull out the faucet. When knob 401 is rotated, a mechanism to secure the faucet position, 416, may be engaged. The mechanism to secure the faucet position may prevent a faucet from moving though the central void 420 when the faucet is in use. The faucet valve assembly may contain contact area 418, to reduce rotational friction. Stem 419, fastener 421, and spring loaded mechanism 407 may adjust for various counter thicknesses by the use of threads, pressure fittings and alignment channels. Fastener 421, may use threads to secure the faucet valve assembly to the mounting surface. There may be threads in Frame 403 to accommodate fastener 421.

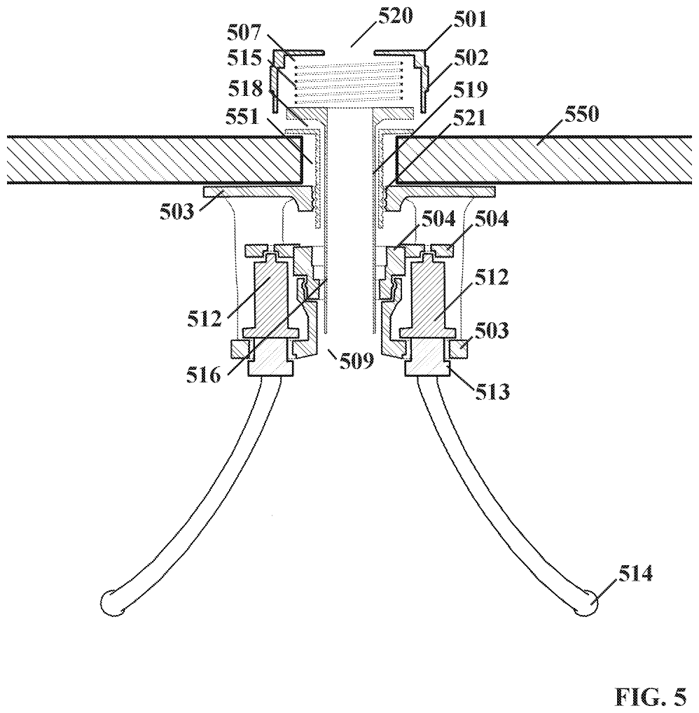

In another embodiment, the faucet valve assembly may be fixed through one central faucet mounting hole. A cross-sectional view in FIG. 5 comprises a control knob, shown in FIG. 5 as 501. The control knob may have grips, 502. Frame, 503, may contain various components in a position located below the mounting surface. Frame 503 may position gears, pulleys, belts or wheels, 404, to transfer rotational movement from knob 501, from the operable side of the mounting surface, to at least one valve, 512. Stem 519 may transfer knob, 501, rotational movement to gears, pulleys, belts or wheels 504. Gears, pulleys, belts or wheels 504 may translate rotational movement amongst at least two gears, pulleys, belts or wheels. The gears, pulleys, belts or wheels may be stacked to provide multiple ratios. The gears, pulleys, belts or wheels may be secured to valves 512. Valves 512, may control the faucet fluid source to result in the provided faucet fluid supply. The inlets and outlets for the faucet fluid source and supply may be at an adjacent, opposite or adjoining location. Valve 512 may reside within frame 503 or it may be part of frame 503. Faucet knob 501 may contain a spring loaded mechanism 507 of which has a spring 515. The spring loaded mechanism may allow for knob 501 to be compressed towards the mounting surface. The result may reveal the faucet head through knob 401 for the user to be able to grab and pull out the faucet. When knob 501 is rotated, a mechanism to secure the faucet position may be engaged. This may occur below the mounting surface, 550, as the mechanism to secure faucet position, 516. The mechanism to secure the faucet position may prevent a faucet from moving though the central void 520 when the faucet is in use. The faucet valve assembly may contain a contact area 518, to reduce rotational friction. Stem 519, and fastener 521, may adjust for various counter thicknesses by the use of threads or alignment channels. Fastener 521, may use threads to secure the faucet valve assembly to the mounting surface. There may be threads in Frame 503 to accommodate fastener 521. In another embodiment, a mechanism to secure faucet position 516, and a spring loaded mechanism 507 may not be necessary as the faucet served by the faucet valve assembly may be a fixed faucet to the assembly, and not a faucet that recesses within the assembly.

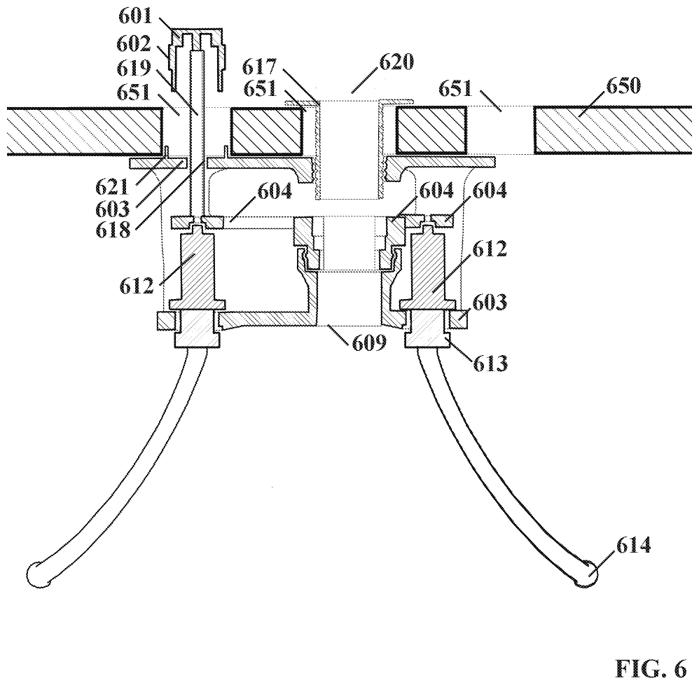

In some embodiments, the faucet valve assembly may be fixed through two or more faucet mounting holes. FIG. 6 is a cross section illustrative embodiment of the faucet valve assembly. Control knob 601 may be positioned at an adjacent mounting hole to the central void 620. Gears, pulleys, belts or wheels, 604, may be controlled from knob 601 and may not require that the central void 620 passes through them. Fastener 621 may be a pressure fit fastener and may be positioned in one or more of the three mounting holes. There may be multiple fasteners for the faucet valve assembly. Stem 619 may pass through a contact area 618 that is located in frame 603 below the mounting surface. Stem top 617 may clamp the mounting surface to secure the faucet valve assembly in place. Faucet head catch, 609, may aligned with a mounting hole. Faucet head catch 609 may facilitate the positioning of the faucet head that may be positioned through the faucet valve assembly.

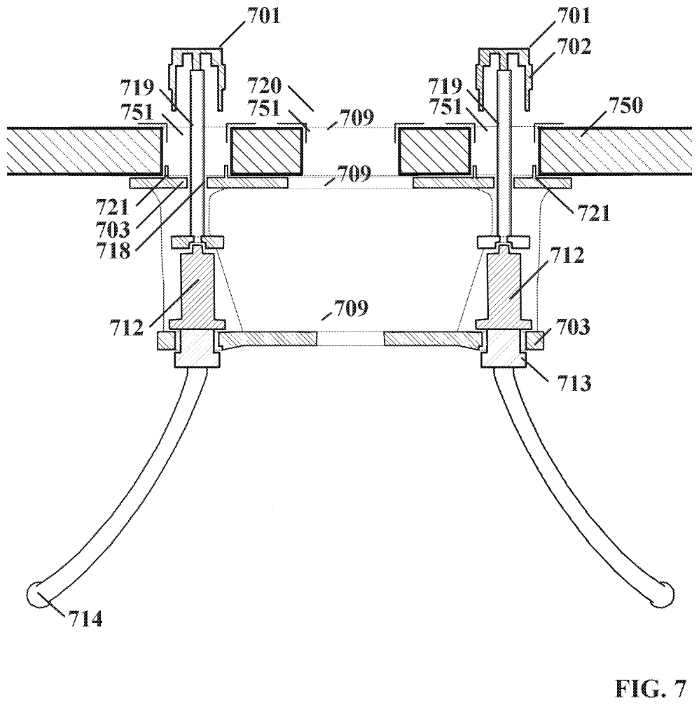

In another embodiment, the faucet valve assembly may be fixed through two or more faucet mounting holes. FIG. 7 is a cross section illustrative embodiment of the faucet valve assembly. Control knob 701 may be through multiple mounting holes. There may be more than one control knob. Fastener 721 may be a pressure fit fastener and may be positioned in any of the three mounting holes. There may be multiple fasteners for the faucet valve assembly. Stem 719 may pass through a contact area 718 that is located in frame 703 below the mounting surface. Faucet head catch, 709, may be located in the mounting hole with central void 720. Faucet head catch 709 may facilitate the positioning of the faucet head that may be positioned through the faucet valve assembly.

1. A faucet valve assembly mounted below the mounting surface.

2. A faucet valve assembly mounted below the mounting surface that uses a control knob positioned above the mounting surface to adjust fluid valves.

3. A faucet valve assembly, with a central void, mounted below the mounting surface and that transfers rotational movement from the user's input above the mounting surface, into valve adjustment below the mounting surface.

4. The faucet valve assembly of claim 1, wherein the faucet valve assembly has a central void that passes through the faucet valve assembly.

5. The faucet valve assembly of claim 1, wherein the faucet valve assembly contains a spring loaded mechanism to aid in moving a part of the faucet through the faucet valve assembly.

6. The faucet valve assembly of claim 1, wherein the control knob is interchangeable.

7. The faucet valve assembly of claim 1, wherein the faucet valve assembly contains a mechanism to secure the associated faucet in position.

8. The faucet valve assembly of claim 1, wherein the faucet valve assembly is fixed through one faucet mounting hole.

9. The faucet valve assembly of claim 1, wherein the faucet valve assembly is fixed through two or more faucet mounting holes.

10. The faucet valve assembly of claim 2, wherein the faucet valve assembly has a central void that passes through the faucet valve assembly.

11. The faucet valve assembly of claim 2, wherein the faucet valve assembly contains a spring loaded mechanism to aid in moving a part of the faucet through the faucet valve assembly.

12. The faucet valve assembly of claim 2, wherein the control knob is interchangeable.

13. The faucet valve assembly of claim 2, wherein the faucet valve assembly contains a mechanism to secure the associated faucet in position.

14. The faucet valve assembly of claim 2, wherein the faucet valve assembly is fixed through one faucet mounting hole.

15. The faucet valve assembly of claim 2, wherein the faucet valve assembly is fixed through two or more faucet mounting holes.

16. The faucet valve assembly of claim 3, wherein the faucet valve assembly contains a spring loaded mechanism to aid in moving a part of the faucet through the faucet valve assembly.

17. The faucet valve assembly of claim 3, wherein the control knob is interchangeable.

18. The faucet valve assembly of claim 3, wherein the faucet valve assembly contains a mechanism to secure the associated faucet in position.

19. The faucet valve assembly of claim 3, wherein the faucet valve assembly is fixed through one faucet mounting hole.

20. The faucet valve assembly of claim 3, wherein the faucet valve assembly is fixed through two or more faucet mounting holes.
